(19) United States
(12) Patent Application Publication
(10) Pub. No.: US 2003/0102594 A1
(43) Pub. Date: Jun. 5, 2003

(54) Method of manufacturing an activated synthetic cottonwool

(76) Inventor: Jangho Choi, Seoul (KR)

Correspondence Address: BACON & THOMAS, PLLC, 625 SLATERS LANE, FOURTH FLOOR, ALEXANDRIA, VA, 22314

(21) Appl. No.: 10/275,256

(22) PCT Filed: Mar. 19, 2001
(86) PCT No.: PCT/KR01/00431

(30) Foreign Application Priority Data
Mar. 12, 2001 (KR) 2001/12586

(51) Int. Cl. B29C 47/00

(52) U.S. Cl. 264/211; 264/211.22

(57) ABSTRACT

Disclosed is a method of manufacturing a functional synthetic cottonwool, comprising the steps of: mixing 0.5˜20% by weight of a mixed powder consisting of 85% by weight of activated charcoal and 15% by weight of a silver-containing inorganic antibacterial carrier, with 80˜99.5% by weight of a base resin selected from polyester, nylon, acryl, polypropylene or silicone; and melt spinning the mixture. The functional synthetic cottonwool has antibacterial and deodorizing effects, radiates far-infrared rays to a human body, and thus promotes the health of a human body when used as a fiberfill of quilts, jackets, etc.

### TECHNICAL FIELD

The present invention relates to a method of manufacturing a functional synthetic cottonwool using activated charcoal, and more particularly to a method of manufacturing a functional synthetic cottonwool which comprises homogeneously mixing charcoal, preferably in the form of a powder, having excellent antibacterial, dehumidifying, deodorizing and purifying actions, with a base resin selected from polyester, nylon, acryl, polypropylene, silicone, etc.

### BACKGROUND ART

In general, the pyrolysis of wood starts at a temperature of above 275° C. After the pyrolysis is complete, black charcoal is obtained at a temperature of between 500˜600° C. and activated charcoal is obtained at a temperature of between 900˜1200° C.

Such activated charcoal contains about 84% of carbon, about 7% of water, about 6% of minerals, about 3% of volatile components, etc. The activated charcoal has strong physical and chemical adsorbtivity.

When physically adsorbed, since electrons between an adsorbent and an adsorbate are not shared, the adsorbate is strongly held on the surface of adsorbent by the attractive force (i.e., dispersion force).

When chemically adsorbed, electron transfer between the adsorbent and the adsorbate confers a strong adsorbtivity.

These adsorbtivities enable charcoal to be effective for antibacterial, dehumidifying, deodorizing and purifying actions. In addition, charcoal acts as a far-infrared ray radiator and an anion emitter.

Various research into uses of activated charcoal having the above-mentioned advantages have been vigorously carried out.

For example, Korean Patent Application No. 1997-0012431 discloses a method for producing a mortar for building materials by adding a charcoal powder to loess. Korean Patent Application No. 1997-0038772 discloses a foil manufactured by using a charcoal powder. Korean Patent Application No. 1999-0006695 discloses a method for producing a charcoal powder-containing paper. Korean Patent Application No. 1998-0060520 discloses an interior panel for construction containing a charcoal powder.

However, these prior arts do not teach or suggest that a functional synthetic cottonwool is manufactured by homogeneously mixing an appropriate amount of an activated charcoal powder having a predetermined particle size, with a base resin such as polyester, nylon, acryl, polypropylene, silicone, etc. In addition, the prior arts have a problem that the properties of activated charcoal cannot be fully exhibited in the products such as mortar, foil, paper and interior panel.

Natural cottonwool, synthetic cottonwool or a mixture thereof mainly used as a fiberfill of mattresses, quilts and pillows has no far-infrared ray radiating effect or anion emitting effect. In addition, no cottonwool exhibits satisfactory moisture absorbing effect, in particular of sweat secreted in a person's sleep, or deodorizing and antibacterial effects.

### DISCLOSURE OF THE INVENTION

Therefore, the present invention has been made in view of the above-mentioned problems., and it is an object of the present invention to provide a method of manufacturing a functional synthetic cottonwool in which activated charcoal is homogeneously mixed, and thus maintaining the inherent properties of activated charcoal.

According to an aspect of the present invention in order to accomplish the above object, there is provided a method of manufacturing a functional synthetic cottonwool which comprises the steps of: mixing 0.5˜20% by weight of a mixed powder consisting of 85% by weight of activated charcoal and 15% by weight of a silver-containing inorganic antibacterial carrier, with 80˜99.5% by weight of a base resin selected from polyester, nylon, acryl, polypropylene or silicone; and melt spinning the mixture in a conventional manner.

In accordance with the present invention, the particle size of the mixed powder is in the range of 0.7 to 2 μm when the thickness of the final cottonwool is not more than 3 deniers. The particle size of the mixed powder is in the range of 1.5 to 7 μm when the thickness of the final cottonwool is 7 deniers. The particle size of the mixed powder is in the range of from 2 μm to 10 μm when the thickness of the final cottonwool is 15 deniers.

In accordance with the present invention, the activated charcoal used herein is obtained by cutting a wood selected from the group consisting of oak, bamboo, Betula Schmidtii, chestnut, mulberry, willow, ash, birch, overcup oak, pine, cherry, camellia, alder and pawlownia in the winter months, drying, heating to 900˜1200° C. in a round kiln, and then crushing to a specific surface area of 2500 to 12000 m²/g.

The silver-containing inorganic based antibacterial carrier is selected from zeolite, titanium dioxide, sericite, biotite, muscovite, illite, mica schist, barium sulfate, tourmaline, etc.

### BEST MODE FOR CARRYING OUT THE INVENTION

The present invention will now be described in more detail with reference to the following Examples.

### EXAMPLE

First, wood was cut (diameter 18˜20 cm×length 1˜1.5 m) during the winter months when the nutrients of wood are richest. Wood was selected from the group consisting of oak, bamboo, Betula Schmidtii, chestnut, mulberry, willow, ash, birch, overcup oak, pine, cherry, camellia, alder and pawlownia.

10 tons of the cut wood was dried in sunlight, upturned to stand the wood's root base upwardly, and closely packed in a kiln. At this time, it is preferable to use a round kiln in order that heat is effectively reflected on the inner surface of the kiln.

Then, the wood was incinerated over a predetermined period (about 7 days). Specifically, the kiln was sealed, lighted, and operated until white smoke from the wood was seen. At this time, the temperature of the kiln was about 400° C., at which the wood was pyrolysed and carbonization was progressed. Further, the wood was incinerated at a temperature of between 900˜1200° C. for 6˜7 days until blue smoke from the wood was observed.

Thereafter, the amount of air introduced into the kiln was controlled so that the volatile gases formed within the kiln were exhausted. The kiln was opened, and cooled by covering it with earth to obtain 1 ton of activated charcoal.

The activated charcoal thus obtained was crushed to form a charcoal powder having a specific surface area of 2500 m²/g to 12000 m²/g, which is suitable size range for mixing with a base resin and melt spinning the mixture.

The charcoal powder thus formed has increased deodorizing, adsorptive and antibacterial effects.

In accordance with the present invention, 15˜45% by weight of an inorganic based antibacterial carrier containing 3˜7% by weight of silver (Ag), based on the total weight of the activated charcoal powder, was added to the activated charcoal powder. The addition of silver-containing inorganic based antibacterial carrier enhances the deodorizing and antibacterial effects.

Examples of silver-containing inorganic based antibacterial carriers usable in the present invention include zeolite, titanium dioxide, sericite, biotite, muscovite, illite, mica schist, barium sulfate, tourmaline, etc.

The method of manufacturing of a functional synthetic cottonwool according to the present invention comprises the step of mixing 0.5˜20% by weight of the mixed powder consisting of the activated charcoal and the silver-containing inorganic based antibacterial carrier, with the base resin, based on the total weight of the functional synthetic cottonwool.

Considering the workability, the average particle size of the mixed powder is in the range of 0.7 to 2 pm when the thickness of the final cottonwool is not more than 3 deniers. The average particle size of the mixed powder is in the range of 1.5 to 7 μm when the thickness of the final cottonwool is 7 deniers. The average particle size of the mixed powder is in the range of 2 to 10 μm when the thickness of the final cottonwool is 15 deniers. When the average particle size of the mixed powder is below 0.7 μm and above 10 μm, the flexibility of cottonwool decreases, melt mixing is difficult and the drawing quality of cottonwool decreases so that cutting frequently occurs during spinning into a yarn.

Mixing of the mixed powder and base resin such as polyester may be carried out by any one of the following procedures: i) the mixed powder was added during the polymerization of base resin to produce a mixed resin chip. Then, the chip was melt spun to manufacture a synthetic cottonwool; and ii) the previously polymerized base resin was mixed with the mixed powder to form a masterbatch. The masterbatch was mixed with the resin, and then melt spun to manufacture a synthetic cottonwool.

When the base resin is acrylic resin, the mixed powder was made in the form of slurry, mixed with the resin, and then spun to manufacture a synthetic cottonwool.

Examples (Examples 1˜8) of synthetic cottonwool manufactured in accordance with the present invention were compared with some examples (Comparative Examples 1˜3) of synthetic cottonwool manufactured without mixing with activated charcoal, in terms of far-infrared emissivity, antibacterial activity and ammonia deodorization rate. The mixed powder used herein consists of 85% by weight of the activated charcoal and 15% by weight of zeolite and mica based inorganic antibacterial carriers. The content of silver in the antibacterial carriers was 5% by weight.

Antibacterial activity was tested using E. coli in accordance with KS method, the evaluation of deodorization was carried out using ammonia gas in accordance with KICM-FIR-1004 method. Far-infrared emissivity was determined using FT-IR at 5 um˜20 um and expressed as an average emissivity. The results are shown in Table 1 below.

TABLE 1

| | Far- | | | | |
|---|---|---|---|---|---|
| | infrared | Anti- | Ammonia | | Mixed |
| | emis- | bacterial | deodori- | Type and | powder |
| | sivity | activity | zation | thickness | content |
| | (%) | (%) | rate (%) | of resin | (wt %) |
| Example 1 | 90 | 94 | 82 | Polyester | 2 |
| | | | | 2 deniers | |
| Example 2 | 91 | 97 | 84 | Acryl | 5 |
| | | | | 2 deniers | |
| Example 3 | 94 | 97 | 89 | Nylon | 7 |
| | | | | 2 deniers | |
| Example 4 | 96 | 99 | 90 | Polypropylene | 15 |
| | | | | 2 deniers | |
| Example 5 | 97 | 99 | 91 | Polyester | 17 |
| | | | | 2 deniers | |
| Comparative | 85 | 12 | 10 | Polyester | 0 |
| Example 1 | | | | 2 deniers | |
| Comparative | 86 | 10 | 12 | Acryl | 0 |
| Example 2 | | | | 2 deniers | |
| Comparative | 90 | 40 | 70 | Polyester | 0 |
| Example 3 | | | | 7 deniers | |
| Example 6 | 91 | 95.5 | 92 | Polyester | 3 |
| | | | | 7 deniers | |
| Example 7 | 95 | 97 | 90 | Polyester | 9 |
| | | | | 15 deniers | |
| Example 8 | 93 | 98.5 | 91 | Polypropylene | 12 |
| | | | | 7 deniers | |

### INDUSTRIAL APPLICABILITY

As can be seen from the foregoing, the functional synthetic cottonwool manufactured in accordance with the present invention has antibacterial and deodorizing effects, radiates far-infrared rays to a human body, and thus promotes the health of a human body when used as a fiberfill of quilts, jackets, etc.

1. A method of manufacturing a functional synthetic cottonwool, comprising the steps of:
mixing 0.5˜20% by weight of a mixed powder consisting of 85% by weight of activated charcoal and 15% by weight of a silver-containing inorganic antibacterial carrier, with 80˜99.5% by weight of a base resin selected from polyester, nylon, acryl, polypropylene or silicone; and
melt spinning the mixture.

2. The method as set forth in claim 1, wherein the particle size of the mixed powder is in the range of 0.7 to 2 μm when the thickness of the cottonwool is not more than 3 deniers, the particle size is in the range of 1.5 to 7 μm when the thickness is 7 deniers, and the particle size is in the range of 2 to 10 μm when the thickness is 15 deniers.

3. The method as set forth in claim 1, wherein the activated charcoal is obtained by cutting a wood selected from the group consisting of oak, bamboo, Betula Schmidtii, chestnut, mulberry, willow, ash, birch, overcup oak, pine, cherry, camellia, alder and pawlownia in the winter months, drying, heating to 900˜1200° C. in a round kiln, and then crushing to a specific surface area of 2500 to 12000 m²/g.

4. The method as set forth in claim 1, wherein the silver-containing inorganic antibacterial carrier is selected from zeolite, titanium dioxide, sericite, biotite, muscovite, illite, mica schist, barium sulfate or tourmaline.
